(19) United States
(12) Patent Application Publication
(10) Pub. No.: US 2005/0018037 A1
(43) Pub. Date: Jan. 27, 2005

(54) Multi-beam laser scanning unit and laser-beam deflection compensating method

(76) Inventor: Tae-kyoung Lee, Suwon-si (KR)

Correspondence Address: STANZIONE & KIM, LLP, 1740 N STREET, N.W., FIRST FLOOR, WASHINGTON, DC, 20036, US

(21) Appl. No.: 10/892,446

(22) Filed: Jul. 16, 2004

(30) Foreign Application Priority Data
Jul. 22, 2003 (KR) 2003-50248
Jan. 27, 2004 (KR) 2004-5105

(51) Int. Cl. B41J 2/45

(52) U.S. Cl. 347/238; 347/233

(57) ABSTRACT

A multi-beam laser scanning unit includes a plurality of laser diodes to emit laser beams, and a rotary polygon mirror to deflect the laser beams emitted from the plurality of laser diodes in a scan direction of a photoconductive medium. The plurality of laser diodes are arranged in a line so that a connecting line of focal points formed by the laser beams forms a vertical line or substantially a vertical line on the photoconductive medium. The multi-beam laser scanning unit may further include a plurality of delay circuits connected to the laser diodes to delay a beam emission time of a first-emitted laser beam among the plurality of laser beams emitted from the laser diodes.

### CROSS-REFERENCE TO RELATED APPLICATIONS

This application claims the benefit of Korean Patent Application Nos. 2003-50248 and 2004-05105, respectively filed on Jul. 22, 2003 and Jan. 27, 2004, the disclosures of which are incorporated herein by reference.

### BACKGROUND OF THE INVENTION

1. Field of the Invention

The present invention relates to a laser scanning unit used with an image forming apparatus, and more particularly, to a multi-beam laser scanning unit which scans a plurality of laser beams, and a beam deflection compensating method.

2. Description of the Related Art

Generally, a laser scanning unit scans laser-beams onto a surface of a photoconductive medium to form an electrostatic latent image corresponding to input image data. Recently, a multi-beam laser scanning unit, capable of scanning a plurality of laser-beams onto a photoconductive medium concurrently, has been developed to provide a high speed and high resolution printing to an image forming apparatus.

FIG. 1 is a schematic view showing a conventional multi-beam laser scanning unit. As shown in FIG. 1, the multi-beam laser scanning unit comprises a multi-beam light source unit 20 for generating a plurality of laser beams, a rotary polygon mirror 30 for deflecting the laser beams emitted from the light source unit 20 toward a photoconductive drum 10 in left and right directions and an f-theta lens 40 for focusing the laser beams deflected from the rotary polygon mirror 30 onto an imaging surface of the photoconductive medium 10 in a spot pattern.

The multi-beam light source unit 20 is disposed at an opening 51 of a casing 50 and includes a multi-beam diode unit 21 for emitting the plurality of laser beams, a laser driving circuit board 22 having two diode driving circuits (not shown) to drive the multi-beam diode unit 21, and a collimating lens 23 for transforming the plurality of laser beams emitted from the multi-beam diode unit 21 to parallel beams.

FIG. 2 is a front elevation view showing a multi-beam light source unit of the conventional multi-beam laser scanning unit of FIG. 1. Referring to FIGS. 1 and 2, the multi-beam diode unit 21 has two laser diodes 24 and 25 to emit two laser-beams. The multi-beam diode unit 21 is connected to the laser driving circuit board 22 such that the two laser diodes 24 and 25 can be inclined at a predetermined angle θ with respect to a horizontal plane. The inclination angle of the two laser diodes 24 and 25 is properly adjusted when the multi-beam diode unit 21 is assembled, such that an imaging point, which is formed on the photoconductive drum 10 by the two laser beams, has a predetermined pitch.

In the conventional multi-beam laser scanning unit with the above construction, the plurality of laser beams emitted from the multi-beam diode unit 21 pass through a cylindrical lens 60, are reflected at the rotary polygon mirror 30, pass through the f-theta lens 40, and are focused onto the photoconductive drum 10 in the spot pattern. A portion of the laser beams, after passing through the f-theta lens 40, is reflected at a mirror 71 and guided to a beam detection sensor 70. The beam detection sensor 70 transmits to a controller of the image forming apparatus a synchronization signal according to the incident portion of the laser beams, and the controller controls the diode driving circuits to adjust beam emission times of the two laser diodes 24 and 25.

However, it is necessary in the conventional multi-beam laser scanning unit to minutely adjust the inclination angle of the two laser diodes 24 and 25 of the multi-beam diode unit 21 so that the imaging point on the imaging surface 11 of the photoconductive drum 10 has the predetermined pitch. Therefore, the number of assembly procedures increases and the assembly procedures become complicated.

Moreover, the conventional multi-beam laser scanning unit has to detect all of the synchronization signals emitted from the plurality of the two laser diodes 24 and 25 and also has to control the beam emission of the laser diodes 24 and 25 using the detected synchronization signals, so a control operation becomes complicated.

### SUMMARY OF THE INVENTION

In order to solve the above and/or other problems, it is an aspect of the present general inventive concept to provide a multi-beam laser scanning unit having simplified assembly procedures and capable of easy control, and a beam deflection compensating method capable of compensating for a beam deflection in a simple manner.

Additional aspects and advantages of the present general inventive concept will be set forth in part in the description which follows and, in part, will be obvious from the description, or may be learned by practice of the general inventive concept.

The above and/or other aspects of the present general inventive concept may be achieved by providing a multi-beam laser scanning unit including a plurality of laser diodes and a rotary polygon mirror. The plurality of laser diodes are arranged in a line so that a connecting line of focal points formed by the laser beams forms a vertical line or substantially a vertical line on a photoconductive medium.

In an aspect of the present general inventive concept, the multi-beam laser scanning unit may further include a plurality of delay circuits connected to the laser diodes to delay a beam emission time of a first-emitted laser beam among the plurality of laser beams emitted from the laser diodes.

In another aspect of the present general inventive concept, the multi-beam laser scanning unit may further include a collimating lens to transform the laser beams emitted from the plurality of laser diodes to parallel beams or substantially parallel beams, and a cylindrical lens to transform the parallel beams passing through the collimating lens to linear beams or substantially linear beams.

The above and/or other aspects of the present general inventive concept may also be achieved by providing a multi-beam laser scanning unit including a plurality of laser diodes including a reference laser diode, a delay circuit, and a rotary polygon mirror. The delay circuit is connected to the laser diodes, except for the reference laser diode, to delay a beam emission time of the laser diodes such that the laser beams emitted from the plurality of laser diodes can be focused on the same vertical plane of the photoconductive medium.

The reference laser diode may be positioned at a top position with respect to the plurality of laser diodes or a lowest position with respect to the plurality of laser diodes.

The above and/or other aspects of the present general inventive concept may also be achieved by providing a beam deflection compensating method of a multi-beam laser scanning unit, the method including emiting laser beams from laser diodes and emitting a first and a second reference laser beams from one of the laser diodes selected as a reference diode toward a rotary polygon mirror to deflect the laser beams of the laser diodes and the first and second reference laser beams of the reference laser diode in a scan direction of a photoconductive medium, detecting a first time interval T₁ between a first time point when the first reference laser beam is incident on a first position of the photoconductive medium, and a second time point when the second reference laser beam is incident on a second position of the photoconductive medium, emitting the first reference laser beam by the reference laser diode toward the rotary polygon mirror and emitting the laser beams by the laser diodes other than the reference laser diode toward the rotary polygon mirror, detecting a second time interval T₂ between a third time point when the first reference laser beam is incident on the first position and a fourth time point when the laser beams emitted from the laser diodes are incident on the second position, and calculating a time difference AT between the first and second time intervals T₁ and T₂ The beam emission time of the laser diodes except for the reference laser diode is delayed by as much as the time difference ΔT.

The reference laser diode emits a laser beam in the scan direction later than other laser diodes or prior to the other laser diodes.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a schematic cross-section view showing a conventional multi-beam laser scanning unit;

FIG. 2 is a front elevation view showing a multi-beam light source unit of the conventional multi-beam laser scanning unit of FIG. 1;

FIG. 3 is a schematic cross-section view showing a multi-beam laser scanning unit according to an embodiment of the present general inventive concept;

FIG. 4 is a block diagram showing the multi-beam laser scanning unit of FIG. 3;

FIG. 5 is a front elevation view showing the parts of the multi-beam laser scanning unit of FIG. 3;

FIGS. 6 and 7 are views showing a beam deflection compensating method of the multi-beam laser scanning unit according to another embodiment of the present general inventive concept;

FIGS. 8 and 9 are views showing an operation of the multi-beam laser scanning unit shown in FIGS. 6 and 7;

FIG. 10 is a block diagram showing a multi-beam laser scanning unit according to another embodiment of the present invention;

FIG. 11 is a front elevation view showing laser diodes of the multi-beam laser scanning unit of FIG. 10; and

FIGS. 12 and 13 are views showing an operation of the multi-beam laser scanning unit of FIG. 10.

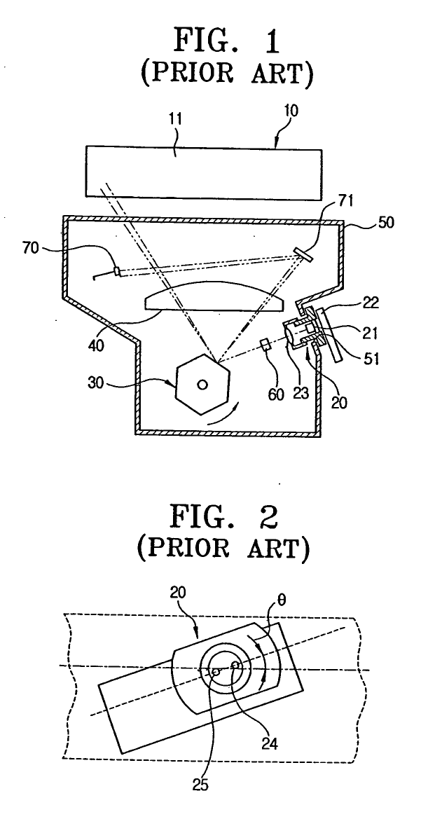

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

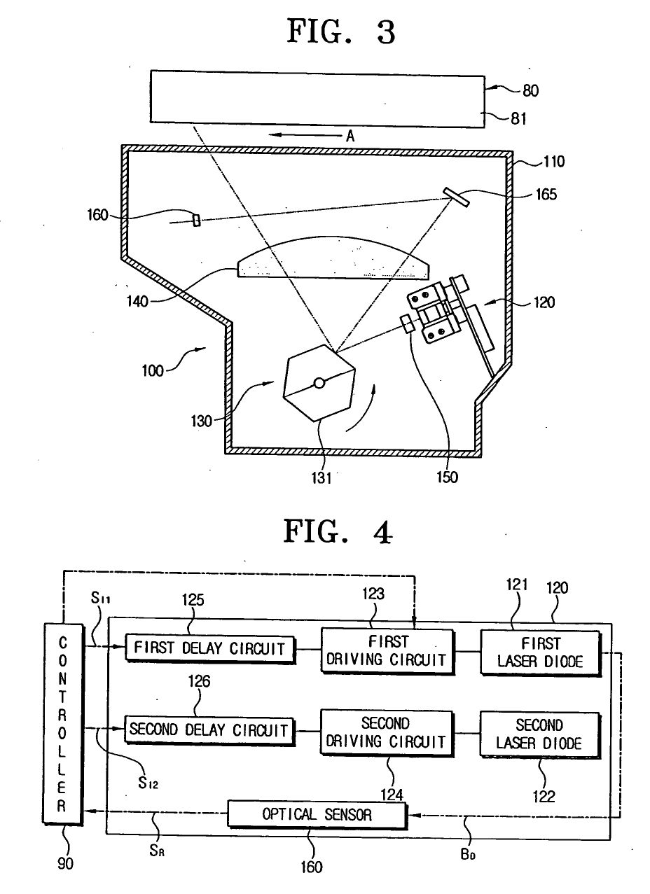

Hereinafter, a multi-beam laser scanning unit and a beam deflection compensating method thereof according to an embodiment of the present general inventive concept will be described in detail with reference to FIGS. 3 to 9.

Referring to FIGS. 3 and 4, a multi-beam laser scanning unit 100 may include a multi-beam light source unit 120, a rotary polygon mirror 130, an f-theta lens 140, a cylindrical lens 150, an optical sensor 160, and a controller 90, all of which are disposed in a casing 110 forming an exterior of the multi-beam laser scanning unit 100.

The multi-beam light source unit 120 may include a first and a second laser diodes 121 and 122, a first and a second driving circuits 123 and 124, a first and a second delay circuits 125 and 126, and a collimating lens (not shown). The first and the second laser diodes 121 and 122 can generate laser beams and can be disposed to face the rotary polygon mirror 130. The first and the second driving circuits 123 and 124 can be connected to the first and the second laser diodes 121 and 122 to drive the first and the second laser diodes 121 and 122, respectively. The first and the second delay circuits 125 and 126 can be connected to the first and the second driving circuits 123 and 124 to delay a time point to emit the laser beams, respectively.

Although in this embodiment, the multi-beam light source unit 120 includes two laser diodes, this should not be considered as limiting. The number of the laser diodes may be three, four and more, and the driving circuits and the delay circuits may also be provided to correspond to the laser diodes.

The rotary polygon mirror 130 may have a plurality of reflection surfaces 131 and rotate at a high speed. The rotary polygon mirror 130 can deflect the laser beams incident on the reflection surfaces 131 in a scan direction A of a photoconductive medium 80. The f-theta lens 140 can focus the laser beams deflected from the rotary polygon mirror 130 onto an imaging surface 81 of the photoconductive medium 80 in a spot pattern. The cylindrical lens 150 can be disposed between the multi-beam light source unit 120 and the rotary polygon mirror 130 and can transform the laser beams emitted from the multi-beam light source unit 120 approximately into a linear beam pattern.

The optical sensor 160 can detect a synchronization detection beam BD emitted from the multi-beam light source unit 120. The synchronization detection beam BD emitted from the multi-beam light source unit 120 can be reflected at a mirror 165 disposed behind the f-theta lens 140 and can impinge on the optical sensor 160. The optical sensor 160 can detect the synchronization detection beam BD and transmit a responsive signal SR corresponding to the synchronization detection beam BD to the controller 90. The controller 90 can receive the responsive signal S_{R} and transmit a first and a second image signals S_{I1}, and S_{I2} to the multi-beam light source unit 120.

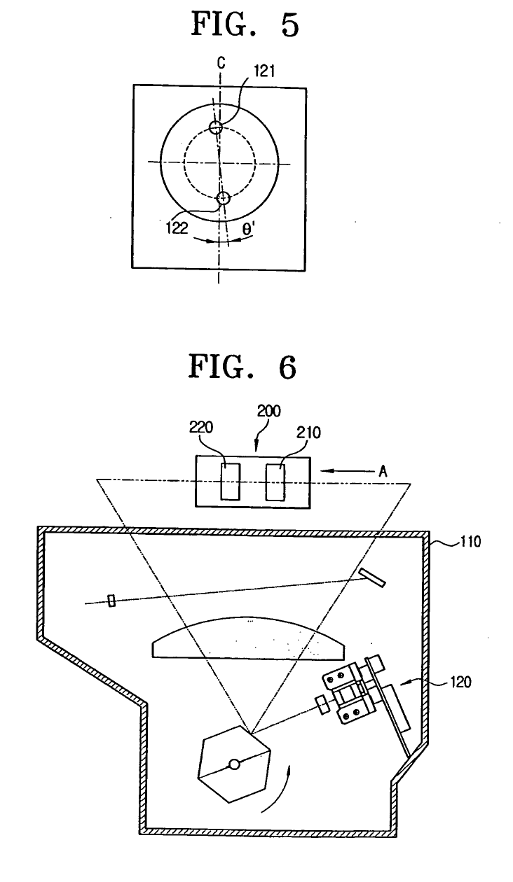

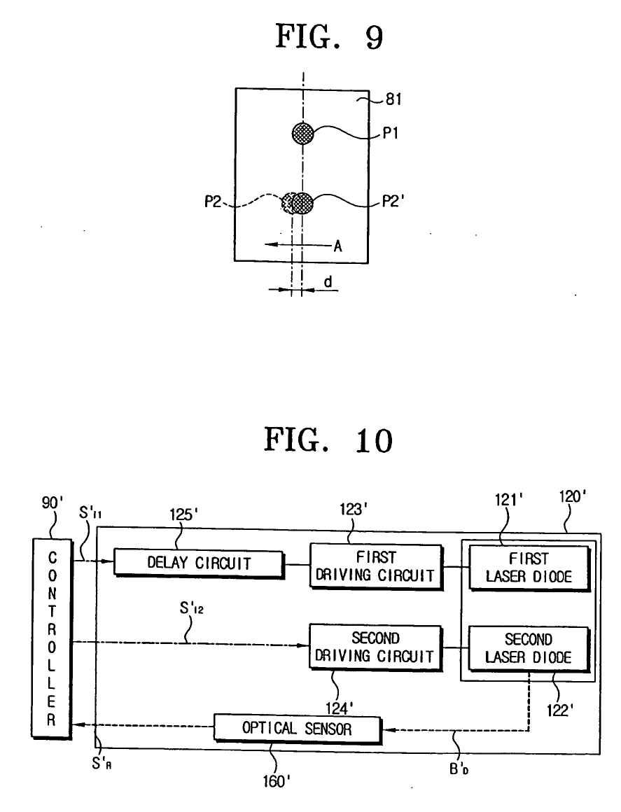

For the assembly of the multi-beam laser scanning unit 100 with the above construction, the multi-beam light source unit 120 can be secured to the casing 110 in an appropriate position so that the first and the second laser diodes 121 and 122 face the rotary polygon mirror 130. The first and the second laser diodes 121 and 122 may be arranged along the same vertical plane or a vertical line C of a vertical plane of the multi-beam light source unit 120 disposed in the casing 110, and in this embodiment, the first and the second laser diodes 121 and 122 may be arranged in a manner such that a connecting line between the first and the second laser diodes 121 and 122 is inclined at a predetermined angle θ′ with respect to the vertical line C as shown in FIG. 5. In this case, since the first and the second laser diodes 121 and 122 are arranged to be deviated from the vertical plane C, the laser beams can be focused on two imaging points P1 and P2, respectively, on a line inclined with respect to a vertical line (corresponding to the vertical plane C) of the imaging surface 81 of the photoconductive medium 80 as shown in FIG. 9. The vertical line of the imaging surface 81 and/or the vertical line C of the multi-beam light source unit 120 may be substantially perpendicular to the scanning direction A of the photoconductive medium 80.

However, this beam deviation can be compensated by delaying an emission of one of the laser beams, such as a first-emitted laser beam, which is emitted in the scan direction A of the imaging surface 81 earlier than the other laser beam, such as a second laser beam. Therefore, the image points P2 is corrected to an image point P2′ which is disposed on the vertical line of the imaging surface 81. Accordingly, the imaging points P1 and P2′ can be formed along the vertical line of the imaging surface 80, which is perpendicular to the scanning direction A, even if the first and the second laser diodes 121 and 122 are arranged along the connecting line which is inclined with respect to the vertical line C, or the first and the second laser diodes 121 and 122 are arranged along the vertical line C of the vertical plane of the multi-beam light source unit 120, according to an aspect of the present general inventive concept, The beam deflection compensating method is as follows.

As shown in FIG. 6, a beam detection sensor 200 can be disposed at a position of the imaging surface 81 of the photoconductive medium 80 so as to detect a time difference AT between a time when the first-emitted laser beam in the scan direction A is focused on a predetermined position, and a time when the second-emitted laser beam is focused on another predetermined position following the first-emitted laser-beam. The beam detection sensor 200 may include two detection units 210 and 220, which are spaced from each other by a predetermined distance.

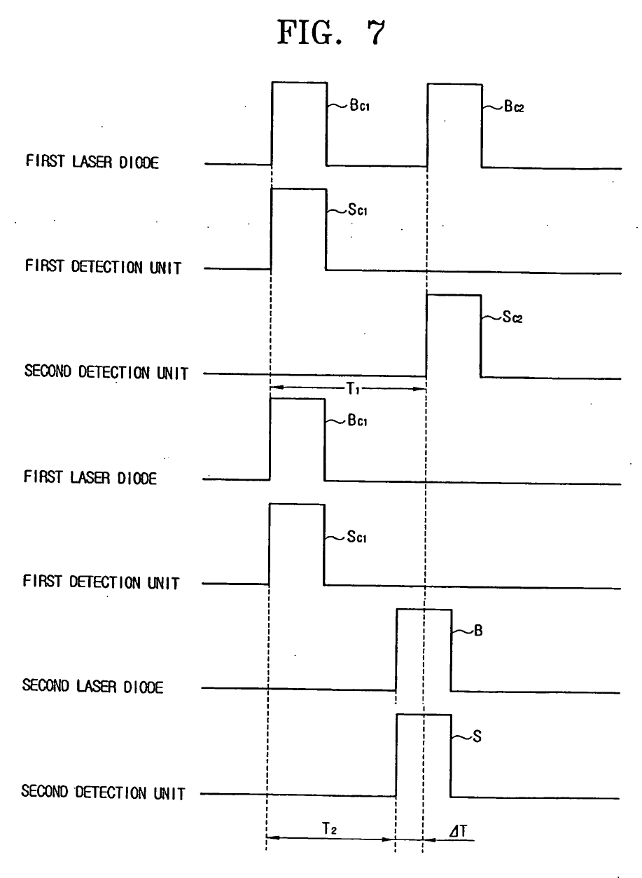

As shown in FIG. 7, when the first laser diode 121 (see FIG. 4) is selected as a reference laser diode to emit a first reference laser beam B_{C1}, the first reference laser beam B_{C1} can be deflected at the rotary polygon mirror 130 (see FIG. 3) to be incident on the first detection unit 210 of the beam detection sensor 200 (see FIG. 6). In response to the first reference laser beam B_{C1}, the first detection unit 210 can generate a signal S_{C1}. When the first detection unit 210 of the beam detection sensor 200 detects the first reference laser beam B_{C1}, the first laser diode 121 can emit a second reference laser beam B_{C2} a predetermined time after the first reference laser beam B_{C1} is emitted. The second reference laser beam B_{C2} can be detected by the second detection unit 220 of the beam detection sensor 200, and a signal S_{C2} responsive to the second reference laser beam BC₂ can be generated by the second detection unit 220. After the signals S_{C1} and S_{C2} are generated in response to the first and the second reference laser beams B_{C1} and BC₂, a first time interval T₁ can be calculated from the signals S_{C1} and S_{C2}.

The first laser diode 121 (see FIG. 4) can emit the first reference laser beam B_{C1}, and the first detection unit 210 can detect the same. After the first detection unit 210 generates the signal S_{C1} in response to the first reference laser beam B_{C1}, and a predetermined time passes, the second laser diode 122 (see FIG. 4) can emit a laser beam B and the second detection unit 220 detects the same to generate a signal S as shown in FIG. 7. A second time interval T₂ between a time when the first reference laser beam B_{C1} is focused on the first detection unit 210, and a time when the laser beam B emitted from the second laser diode 122 is focused on the second detection unit 220, can be calculated.

After both first and second time intervals T₁ and T₂ are calculated, the time difference ΔT between T₁ and T₂ can be calculated (ΔT=T₁−T₂). The time difference ΔT can be a beam emission delay time of the second laser diode 122. The second laser diode 122 can delay a next laser beam B in the scan direction A by the beam emission delay time with respect to the first reference laser beam B_{C1} of the first laser diode 121.

In this embodiment, because the laser beam is emitted from the first laser diode 121 to follow the laser beam emitted from the second laser diode 122 in the scan direction A, the time difference ΔT becomes a positive value, and the first laser diode 121 is selected as the reference laser diode. If the time difference ΔT becomes a negative value, the second laser diode 122 can be selected as the reference laser diode.

When the time difference ΔT between the first and second time intervals T₁ and T₂, i.e., a beam emission delay time, Δ is calculated, the second delay circuit 126 (refer to FIG. 4) is set so that a beam emission time of the second laser diode 122 is delayed from a beam emision time of the first laser diode by as much as the time difference AT. At this time, the first delay circuit 125 (see FIG. 4) is neither set nor operated.

In another aspect of the present general inventive concept, the beam emission delay time may be calculated according to at least one laser beam of the second laser diode 122 selected as the reference laser diode. That is, one laser diode emitting a laser beam in the scan direction A after the other laser diode, can be selected as the reference laser diode. In this case, the beam emission delay time can be calculated from a laser beam of the other laser diode with respect to the laser beam of the one laser diode.

Hereinafter, the operation of multi-beam laser scanning unit 100 according to this embodiment of the present invention in which the setting of the delay circuit is completed, will be described.

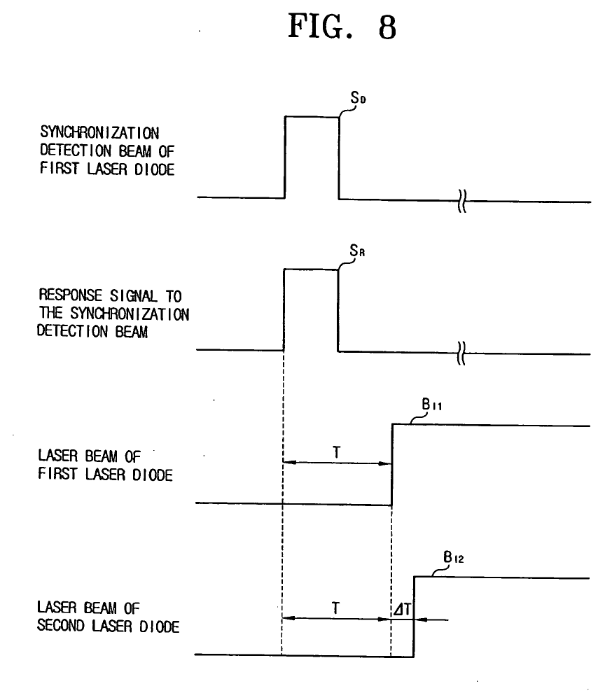

As shown in FIGS. 4 and 8, when a synchronization detection beam B_{D} is emitted from the first laser diode 121 selected as the reference laser diode, the synchronization detection beam B_{D} can be reflected by the mirror 165 (see FIG. 3) and can impinge on the optical sensor 160 (see FIG. 3). At this time, the optical sensor 160 can transmit a response signal SR to the controller 90 in response to the synchronization detection beam B_{D}. The controller can transmit both a first and a second image signals S_{I1}, and S_{I2} to the multi-beam light source unit 120 a predetermined time T after the response signal S_{R} is received. At this time, the first image signal S_{I1}, can be transmitted to the first driving circuit 123 through the first delay circuit 125, and the first driving circuit 123 can control the first laser diode 121 to generate a laser beam to form an image. Accordingly, the first laser diode 121 can emit a laser beam B_{I1} to form an image after the synchronization detection beam B_{D} is detected and the predetermined time T passes. Conversely, since the second image signal S_{I2} is transmitted to the second driving circuit 124 through the second delay circuit 126 which is set to delay by as much as the time difference ΔT, the second laser diode 122 emits a laser beam B_{I2} after the synchronization detection beam BD is detected and the time T+ΔT passes, as shown in FIG. 8.

After the laser beams B_{I1}, and B_{I2} emitted from the first and the second laser diodes 121 and 122 pass through the collimating lens and the cylindrical lens 150, they can be deflected at the rotary polygon mirror 130 and focused on the imaging surface 81 of the photoconductive medium 80, as shown in FIG. 3. At this time, since the beam emission time of the second laser diode 122 is delayed, focal points P1 and P2′ of the first and the second laser beams B_{I1} and B_{I2} are located on the same vertical plane of the imaging surface 81 as shown in FIG. 9.

In the previous embodiment shown in FIGS. 4 and 5, a beam deviation occurs when the laser beam is emitted from the second laser diode 122 in the scan direction A of the imaging surface 81 prior to the laser beam from the first laser diode 123. That is, the first laser diode 123 is selected as the reference laser diode and the second delay circuit 126 is operated. However, this should not be considered as limiting to the present general inventive concept. That is, if a beam deviation occurs from the laser beam emitted from the first laser diode 121 to precede in the scan direction A the laser beam emitted from the second laser diode 122, the first delay circuit 125 can operated in order to delay the beam emission time of the first laser diode 121. In this case, the second delay circuit 126 does not operate, but the first delay circuit 125 operates.

Also, if more than two laser diodes, such as three, four, or more, are provided in the multi-beam light source unit 120, a laser diode emitting the laser beams in the scan direction A after another laser diode emits a beam, is selected as the reference laser diode. Accordingly, the beam emission times of the respective laser diodes can be delayed except for the reference laser diode. 1

FIGS. 10 to 13 are views showing a multi-beam laser scanning unit according to another embodiment of the present general inventive concept, and an operation thereof. Hereinafter, the multi-beam laser scanning unit according to this embodiment of the present general inventive concept will be described.

The multi-beam laser scanning unit of FIG. 10 is similar to the multi-beam laser scanning unit of the embodiment of FIG. 4 except for a multi-beam light source unit 120′. Accordingly, like reference numerals refer to like components of the laser scanning unit 100 according to the embodiment shown in FIGS. 3 and 4, and thus detailed description will be omitted for the consciousness.

As shown in FIG. 10, the multi-beam light source unit 120′ may include a first and a second laser diodes 121′ and 122′, a first and a second driving circuits 123′ and 124′, a delay circuit 125′, an optical sensor 160′, a rotary polygon sensor 130 (see FIG. 3), a cylindrical lens 150 (see FIG. 3), and an f-theta lens 140 (see FIG. 3). In this embodiment, the multi-beam light source unit 120′ has the same structure as the multi-beam light source unit 120 of the laser scanning unit 100 shown in FIGS. 3 and 4 except for the delay circuit 125′. The delay circuit 125′ can be connected to the first driving circuit 123′ to delay a beam emission time of the first laser diode 121′.

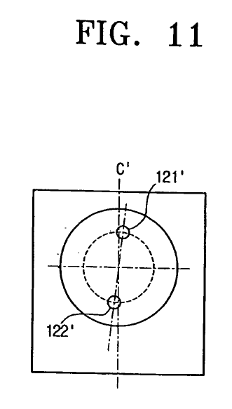

The multi-beam light source unit 120′ with the above construction can be assembled in a manner such that a connecting line between the first and the second laser diodes 121′ and 122′ is inclined with respect to a vertical plane C′ as shown in FIG. 11. With the arrangement of the first and the second laser diode 121′ and 122′ as shown in FIG. 11, laser beams emitted from the first and the second laser diodes 121′ and 122′ can be focused on the imaging surface 81 of the photoconductive medium 80 (see FIG. 3) as shown in FIG. 13. That is, the laser beam emitted from the first laser diode 121′ may have a focal point Q1 preceding a focal point Q2 of the laser beam emitted from the second laser diode 122′ in the scan direction A. Accordingly, there occurs a certain distance d′ between two imaging points Q1 and Q2 with respect to a vertical line perpendicular to the scanning direction A.

To compensate for such a deviation of beams, a beam emission time of the first laser diode 121′ can be delayed. Accordingly, a beam emission delay time ΔT′ of the first laser diode 121′ to align the focal points Q1 and Q2 of the laser beams in the same vertical plane (line), can be obtained using the beam detection sensor 200 (see FIG. 6) disposed on the imaging surface 81. The beam emission delay time ΔT′ can be obtained in the same method as used in the multi-beam laser scanning unit 100 of the embodiment of FIGS. 3 and 4, and therefore, detailed description is omitted for consciousness.

A difference between the embodiment of FIGS. 3 and 4 and the embodiment of FIG. 10 is that since the laser beam emitted from the second laser diode 122′ precedes the laser beam of the first laser diode 121′ on the imaging surface 81 in the scan direction A, the second laser diode 122′ can be selected as the reference diode. Accordingly, when the second laser diode 122′ emits a first and a second reference laser beams B_{C1} and B_{C2} (see FIG. 7), time intervals T_{1 and T}₂ can be calculated using the first and the second reference laser beams B_{C1} and B_{C2} and, a time difference between the time intervals T₁ and T₂, i.e., the beam emission delay time ΔT′, is calculated.

When the beam emission delay time ΔT′ of the first laser diode 121′ is calculated, the delay circuit 125′ can be set to delay the beam emission time of the first laser diode 121′ by the time difference ΔT′.

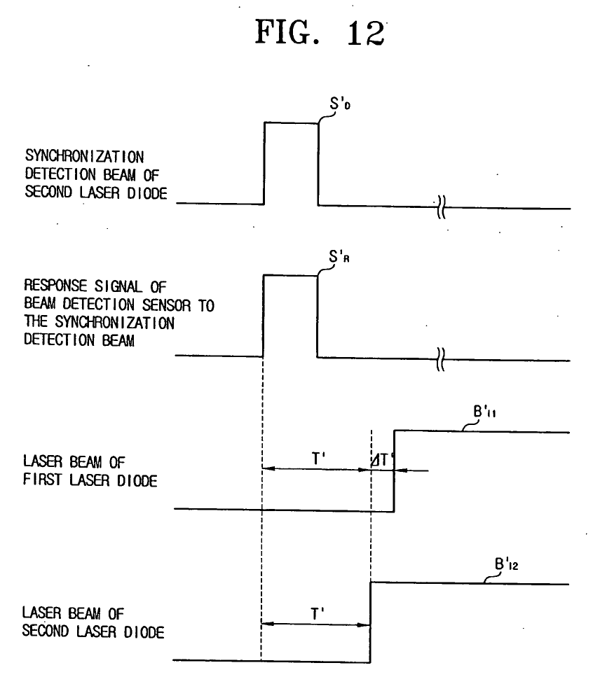

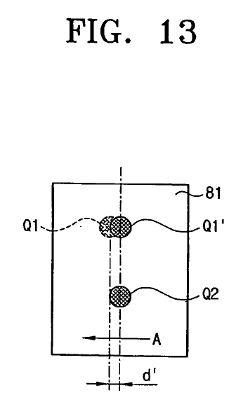

In the multi-beam laser scanning unit with the above construction according to this embodiment, the second laser diode 122′ selected as the reference diode can emit a synchronization detection beam B_{D}′ when a printing starts, as shown in FIG. 10. The synchronization detection beam B_{D}′ can be detected by the optical sensor 160′, and in response to the synchronization detection beam B_{D}′, the optical sensor 160′ can transmit a response signal S′_{R} to the controller 90. Upon receiving the response signal S′_{R}, the controller 90 can transmit a first and a second image signal S′_{I1} and S′_{I2} to the multi-beam light source unit 120′, and the first and the second driving circuits 123′ and 124′ can control the first and the second laser diodes 121′ and 122′, respectively, according to the image signals S′_{I1} and S′_{I2}. At this time, as shown in FIG. 12, the second laser diode 122′ can emit a laser beam to form an image after the synchronization detection beam B′_{D} reaches the optical sensor 160′ (see FIG. 10),and a predetermined time T′ passes. Meanwhile, the first laser diode 121′ can emit a laser beam to form another image after a time T′+ΔT′ passes due to the delay circuit 125′.

As described above, by delaying the beam emit time of the first laser diode 121′ by the time difference ΔT′, the focal points Q′1 and Q2 of the laser beams B′_{I1} and B′_{I2} emitted from the first and the second laser diodes 121′ and 122′, respectively, can be aligned on the same vertical plane of the imaging surface 81.

In this embodiment, the second laser diode 122′ can be selected as the reference laser diode, and the first laser diode 121′ can be connected to the delay circuit 125. However, in an alternative example, the first laser diode 121′ can be selected as the reference laser diode, and the second laser diode 122′ can be connected to the delay circuit. In latter case, the first and the second laser diodes 121′ and 122′ are arranged so that the laser beam emitted from the second laser diode 122′ precedes the laser beam emitted from the first laser diode 121′ on the imaging surface 81 in the scan direction A.

Also, if more than two laser diodes, such as three, four or more laser diodes, are provided, the laser diodes may be arranged in a line and the delay circuit is connected to laser diodes except for a reference diode which positioned either at the top position or bottom position of the multi-beam light source. By delaying the beam emission time of the laser diodes except for the reference diode, the focal points formed by the laser beams emitted from all of the laser diodes can be arranged on the same vertical plane of the imaging surface.

As described above, since the plurality of laser diodes are arranged on the same vertical plane with a small pitch, it is possible to exclude a process of inclining the multi-beam diode unit at a pre-set angle to adjust a pitch between the focal points on the imaging surface of the photoconductive drum. Accordingly, assembly processes can be reduced and simplified.

Also, in the multi-beam laser scanning unit according to the embodiments of the present general inventive concept, by delaying the beam emission time of the laser diode using the delay circuit, the beam deflection between the laser beams can be compensated in a simple manner.

Also, according to the embodiment of the present general inventive concept, since the beam emit times of all of the laser diodes can be determined by one single synchronization detection beam emitted from one reference diode among the plurality of laser diodes, the multi-beam laser scanning unit can be controlled in a simple manner.

The foregoing embodiments and advantages are merely exemplary and are not to be construed as limiting the present general inventive concept. Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A multi-beam laser scanning unit comprising:
a plurality of laser diodes to emit laser beams; and
a rotary polygon mirror to deflect the laser beams emitted from the plurality of laser diodes in a scan direction of a photoconductive medium,
wherein the plurality of laser diodes are arranged along a line so that a connecting line of focal points formed on the photoconductive medium by the laser beams forms substantially a vertical line of the photoconductive medium.

2. The multi-beam laser scanning unit as claimed in claim 1, further comprising:
a plurality of delay circuits connected to the laser diodes to delay a beam emission time of one of the plurality of laser beams emitted from the laser diodes.

3. The multi-beam laser scanning unit as claimed in claim 1, further comprising:
a collimating lens to transform the laser beams emitted from the plurality of laser diodes to substantially parallel beams.

4. The multi-beam laser scanning unit as claim in claim 3, further comprising:
a cylindrical lens to transform the parallel beams passing through the collimating lens to substantially linear beams.

5. A multi-beam laser scanning unit comprising:
at least one laser diode to emit a laser beam to form an image on a photoconductive medium;
a reference laser diode to emit a reference laser beam in a scan direction of the photoconductive medium, the reference laser beam emitted after the laser beam is emitted from the laser diode;
a delay circuit connected to the laser diode to delay a beam emission time of the laser diode such that the laser beam emitted from the laser diode and the reference laser beam emitted from the reference laser beam can be focused on the same vertical line of a plane of the photoconductive medium; and
a rotary polygon mirror to deflect the laser beam emitted from the laser diode and the reference laser beam emitted from the reference diode in the scan direction of the photoconductive medium.

6. The multi-beam laser scanning unit as claimed in claim 5, wherein the reference laser diode is positioned at a higher position than the laser doide.

7. The multi-beam laser scanning unit as claimed in claim 5, wherein the reference laser diode is positioned at a lower position than the laserdiode.

8. The multi-beam laser scanning unit as claimed in claim 5, further comprising:
a collimating lens to transform the laser beam emitted from the laser diode and the reference laser beam emitted from the reference diode to substantially parallel beams.

9. The multi-beam laser scanning unit as claimed in claim 8, further comprising:
a cylindrical lens to transform the parallel beams passing through the collimating lens to substantially linear beams.

10. A beam deflection compensating method of a multi-beam laser scanning unit, the method comprising:
emitting a first and a second reference laser beams from a reference diode toward a rotary polygon mirror to deflect the first and second reference laser beams of the reference laser diode in a scan direction of a photoconductive medium;
detecting a first time interval between a time point when the first reference laser beam is incident on a first position of an imaging surface of the photoconductive medium and a time point when the second reference laser beam is incident on a second position of the imaging surface of the photoconductive medium;
emitting a first laser beam by the reference laser diode toward the rotary polygon mirror, and emitting a second laser beam by another laser diode toward the rotary polygon mirror;
detecting a second time interval between a time point when the first laser beam is incident on the first position and a time point when the second laser beam emitted from the another laser diode is incident on the second position of the imaging surface; and
calculating a time difference between the first and second time intervals,
wherein the beam emission time of the another laser diode is delayed according to the time difference.

11. The beam deflection compensating method as claimed in claim 10, wherein the reference laser diode emits the first laser beam in the scan direction later than the another laser diode.

12. The beam deflection compensating method as claimed in claim 10, wherein the reference laser diode emits the first laser beam in the scan direction prior to the another laserdiode.

13. A multi-beam laser scanning unit used with an image forming apparatus having a photoconductive medium, comprising:
a first laser diode to emit a first laser beam to form a first focal point on the photoconductive medium along a scanning direction of the photoconductive medium;
a second laser diode to emit a second laser beam to form a second focal point on the photoconductive medium along the scanning direction of the photoconductive medium; and
a circuit to adjust a beam emission time of the second laser beam of the second laser diode with respect to a reference signal so that the first and second focal points are disposed on a line perpendicular to the scanning direction of the photoconductive medium regardless of positions of the first and second laser diodes.

14. The multi-beam laser scanning unit as claimed in claim 13, further comprising:
a multi-beam light source unit on which the first laser diode and the second laser diode are disposed, wherein the first laser diode and the second laser diode are disposed on a vertical line perpendicular to the scanning direction.

15. The multi-beam laser scanning unit as claimed in claim 13, further comprising:
a multi-beam light source unit on which the first laser diode and the second laser diode are disposed,
wherein the first laser diode and the second laser diode are disposed on a line inclined with respect to a vertical line perpendicualr to the scanning direction by a deviation angle.

16. The multi-beam laser scanning unit as claimed in claim 15, wherein the circuit delays the second laser beam of the second laser diode according to the beam emission time corresponding to the deviation angle so that the deviation angle of the line with respect to the vertical line of the multi-beam light source is compensated.

17. The multi-beam laser scanning unit as claimed in claim 15, wherein the circuit does not adjust another beam emission time of the first laser beam of the first laser diode.

18. The multi-beam laser scanning unit as claimed in claim 13, further comprising:
a controller to genenrate the reference signal according to the first laser beam of the first diode and to calculate the beam emission time of the second laser beam of the second laser diode,
wherein the beam emission time of the second laser beam of the second laser diode is adjusted with respect to the first laser beam of the first laser doide while another beam emission time of the first laser beam of the first laser diode is not adjusted with respect to the second laser beam of the second laser diode.

19. The multi-beam laser scanning unit as claimed in claim 13, wherein the first laser diode emits a synchronization beam as a portion of the reference signal, and the beam emission time is obtained from a first time interval between the synchronization beam and the first laser beam and a second time interval between the synchronization beam and the second laser beam.

20. The multi-beam laser scanning unit as claimed in claim 13, wherein the beam emission time with respect to the reference signal is obtained according to another beam emission time of the first laser beam.

21. The multi-beam laser scanning unit as claimed in claim 13, further comprising:
a beam detection sensor having first and second detection units to detect the first and second laser beams to generate times used for generating the beam emission time.

22. The multi-beam laser scanning unit as claimed in claim 21, wherein the first laser diode and the second laser diode are disposed on a line inclined with respect to a vertical line perpendicular to the scanning direction by a deviation angle, and the circuit delays the second laser beam of the second laser diode according to the times of the first and second laser diodes so that the deviation angle is compensated.

23. A beam deflection compensating method of a multi-beam laser scanning unit used with an image forming apparatus having a photoconductive medium, the method comprising:
emitting a first laser beam from a first laser diode to form a first focal point on the photoconductive medium along a scanning direction of the photoconductuve medium;
emitting a second laser beam from a second laser diode to form a second focal point on the photoconductive medium along the scanning direction of the photoconductive medium; and
adjusting a beam emission time of the second laser beam of the second laser diode so that the first and second focal points are disposed on a line perpendicular to the scanning direction of the photoconductive medium regardless of positions of the first and second laser diodes.

24. The method as claimed in claim 23, further comprising:
emitting a synchronization beam from the first laser diode; and
generating the beam emission time according to a first time interval between the synchronization beam and the first laser beam and a second time interval between the synchronization beam and the second laser beam.

25. The method as claimed in claim 23, further comprising:
generating the beam emission time according to emission times of the first and second laser beams emitted from the first and second laser diodes, respectively.

26. The method as claimed in claim 23, further comprising:
displacing the first laser diode and the second laser diode on a vertical line of a multi-beam light source unit perpendicular to the scanning direction.

27. The method as claimed in claim 23, further comprising:disposing the first laser diode and the second laser diode on a line inclined with respect to a vertical line perpendicular to the scanning direction by a deviation angle; and
delaying the second laser beam of the second laser diode according to the beam emission time corresponding to the deviation angle.

28. An image forming apparatus having a photoconductive medium, comprising:
a first laser diode to emit a first laser beam to form a first focal point on the photoconductive medium along a scanning direction of the photoconductive medium;
a second laser diode to emit a second laser beam to form a second focal point on the photoconductive medium along the scanning direction of the photoconductive medium; and
a circuit to adjust a beam emission time of the second laser beam of the second laser diode with respect to a reference signal so that the first and second focal points are disposed on a line perpendicular to the scanning direction of the photoconductive medium regardless of positions of the first and second laser diodes, wherein the first and second laser beams form an image to be printed.
